(19) United States
(12) Patent Application Publication
(10) Pub. No.: US 2011/0048157 A1
(43) Pub. Date: Mar. 3, 2011

(54) MECHANICAL ARM ASSEMBLY

(75) Inventors: BO LONG, Shenzhen City (CN); XIAO-MING XU, Shenzhen City (CN)

(73) Assignees: HONG FU JIN PRECISION INDUSTRY (ShenZhen)CO., LTD., Shenzhen city (TW); HON HAI PRECISION INDUSTRY CO., LTD., Tu-Cheng (TW)

(21) Appl. No.: 12/636,877

(22) Filed: Dec. 14, 2009

(30) Foreign Application Priority Data
Sep. 3, 2009 (CN) 200910306544.X

(51) Int. Cl. B25J 17/00; B25J 18/00

(52) U.S. Cl. 74/490.03; 74/490.05; 74/490.04

(57) ABSTRACT

A mechanical arm assembly includes a first mechanical arm, a second mechanical arm and a harmonic speed reducer. The harmonic speed reducer rotatably connects the second mechanical arm to the first mechanical arm. The harmonic speed reducer includes a wave generator, a flexible wheel, and a rigid wheel. The flexible wheel is connected to the wave generator. A portion of the rigid wheel is meshed with a portion of the flexible wheel. One of the flexible wheel and the rigid wheel is fixedly connected to the first mechanical arm, and the other of the flexible wheel and the rigid wheel is fixedly connected to the second mechanical arm, thus supporting the second mechanical arm and causing rotation of the second mechanical arm.

### BACKGROUND

1. Technical Field

The present disclosure relates generally to mechanical arm assemblies and, more particularly, to a mechanical arm assembly for a robot.

2. Description of Related Art

An industrial robot generally includes a plurality of connected mechanical arms. An end mechanical arm can support clamping apparatus or detectors to clamp workpieces. A joint mechanism is assembled between a first mechanical arm and a second mechanical arm for rotatably connecting the two mechanical arms. The joint mechanism generally includes a speed reducer with a housing and an output shaft. The housing is fixed in a first assembly hole of the first mechanical arm. The output shaft is fixed to an assembly end of the second mechanical arm. The assembly end of the second mechanical arm is further connected to a bearing received in a second assembly hole of the first mechanical arm. The bearing is opposite to the speed reducer.

During assembly of the industrial robot, the output shaft of the speed reducer normally aligns with a rotating axis of the bearing, avoiding damage to the speed reducer and the second mechanical arm during rotation of the second mechanical arm.

However, the output shaft of the speed reducer often cannot precisely align with the rotating axis of the bearing, due to machining precision of the described components of the industrial robot. An adjusting ring is generally positioned in the second assembly hole to adjust concentricity of the output shaft of the speed reducer and the rotating axis of the bearing. The adjusting ring is ground many times to achieve a suitable size for the industrial robot. Accordingly, assembly efficiency of the industrial robot is affected.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an exemplary embodiment of a mechanical arm assembly.

FIG. 2 is an exploded, isometric view of the mechanical arm assembly of FIG. 1.

FIG. 3 is similar to FIG. 2, but viewed from another aspect.

FIG. 4 is a cross-section of the mechanical arm assembly of FIG. 1.

FIG. 5 is a sketch-map of a flexible wheel and a rigid wheel of FIG. 1.

FIG. 6 is a sketch-map of the flexible wheel and the rigid wheel of FIG. 1, with a wave generator engaging in the flexible wheel.

### DETAILED DESCRIPTION

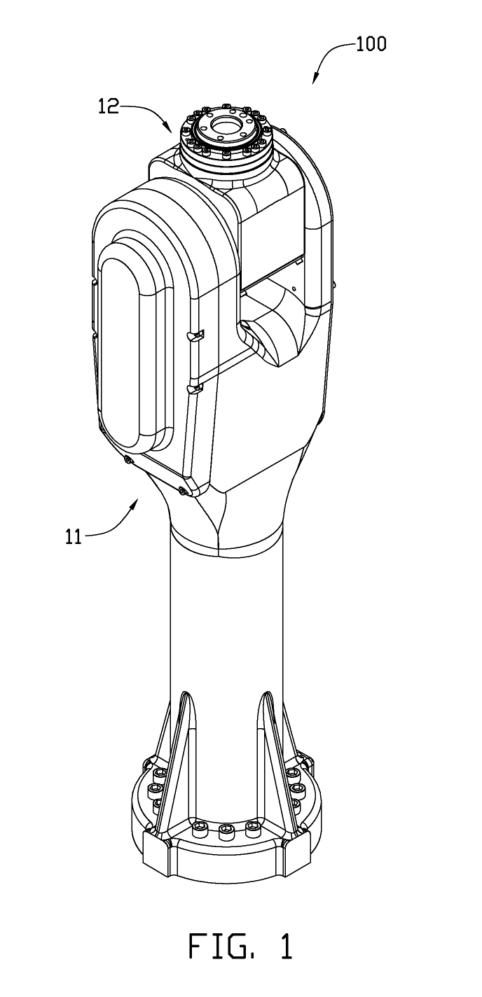

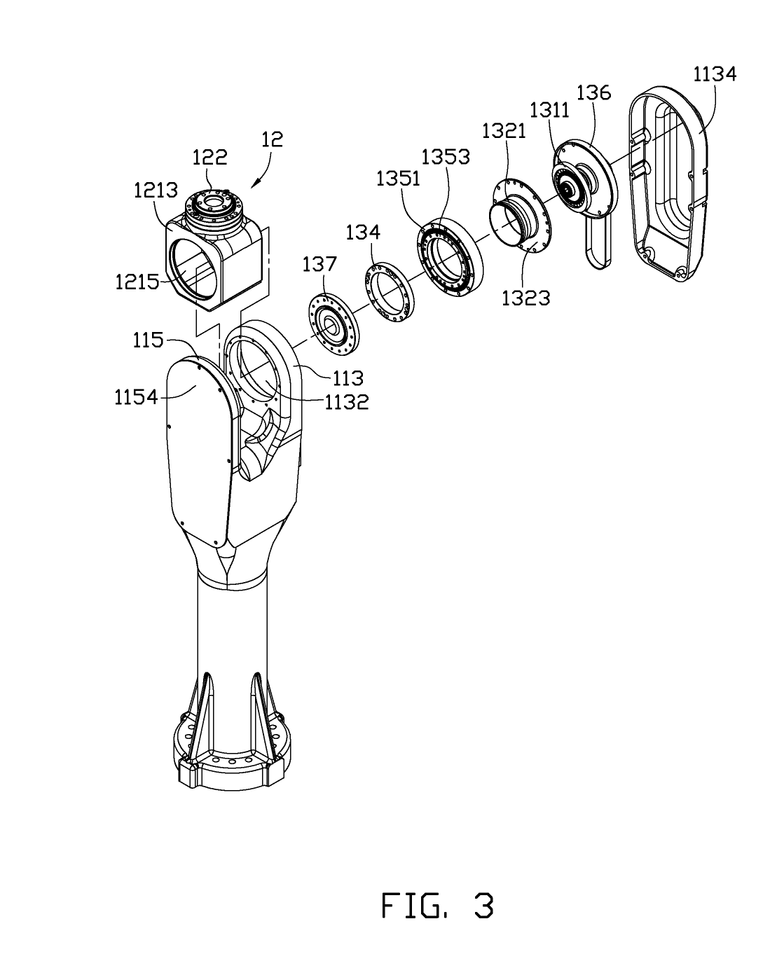

Referring to FIGS. 1 through 4, an exemplary embodiment of a mechanical arm assembly 100 for a robot (not shown) includes a first mechanical arm 11, a second mechanical arm 12, a harmonic speed reducer 13, and a driving module 21. The second mechanical arm 12 is rotatably connected to the first mechanical arm 11. In the illustrated embodiment, the mechanical arm 100 is used for a six-axis robot (not shown). The six-axis robot has a controller (not shown), for controlling movement of the assembly components. The first mechanical arm 11 is positioned on a fifth rotatable axis of the six-axis robot, and the second mechanical arm 12 is positioned on a sixth rotatable axis of the six-axis robot.

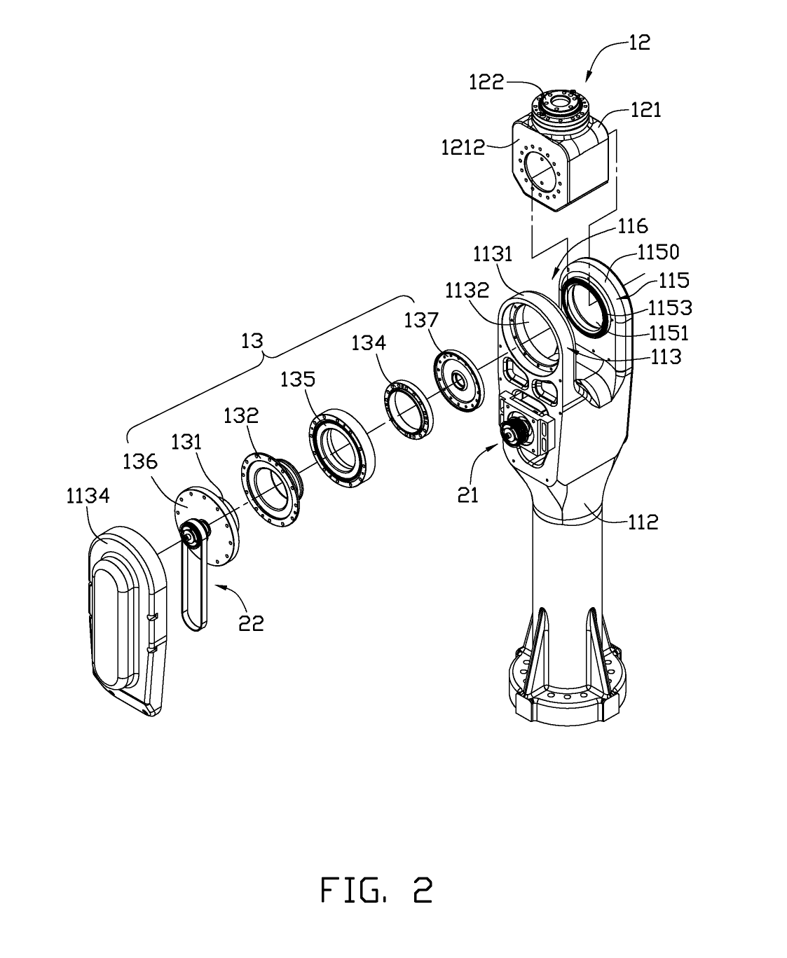

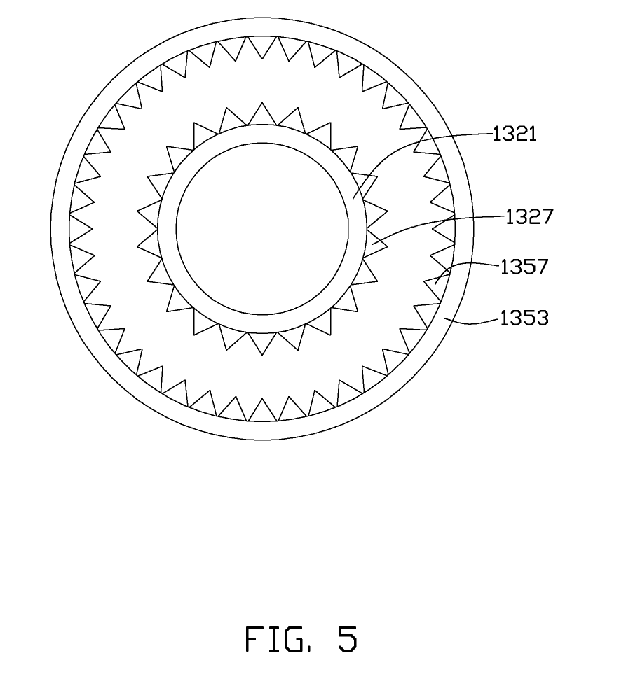

Referring to FIGS. 2, 3, 5 and 6, the harmonic speed reducer 13 includes a wave generator 131, a flexible wheel 132, a rigid wheel 134, a cross roller bearing 135, a first side cover 136, and a second side cover 137. The wave generator 131 has a rotatable portion 1311, and the rotatable portion 1311 is substantially elliptic. The flexible wheel 132 includes a hollow cylindrical main body 1321 and a flange 1323 formed on an end of the main body 1321. The main body 1321 is substantially circular ring shaped. The rigid wheel 134 is substantially circular ring shaped. The flexible wheel 132 forms a plurality of outer teeth 1327 at a periphery of the main body 1321, and the rigid wheel 134 forms a plurality of inner teeth 1347 at the inner surface. An outer radius of the main body 1321 is shorter than an inner radius of the rigid wheel 134 (as shown in FIG. 5). Therefore, there are less outer teeth of flexible wheel 132 than inner teeth of the rigid wheel 134. One of the flexible wheel 132 and the rigid wheel 134 is fixed to the first mechanical arm 11, and the other of the flexible wheel 132 and the rigid wheel 134 is fixed to the second mechanical arm 12. In the illustrated embodiment, the flexible wheel 132 is fixed to the first mechanical arm 11, and the rigid wheel 134 is fixed to the second mechanical arm 12, unilaterally supporting the second mechanical arm 12.

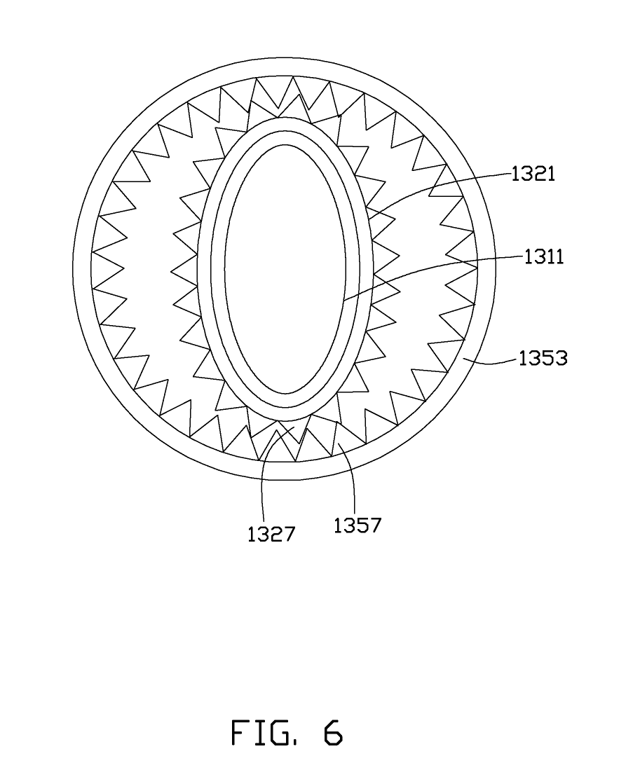

The wave generator 131 is connected to the driving module 21 via the transmission member 22. When the rotatable portion 1311 of the wave generator 131 is assembled in the main body 1321 of the flexible wheel 132, the circular main body 1321 can be elastically deformed to an elliptical shape (as shown in FIG. 6). Thus, the outer teeth 1327 of the flexible wheel 132 can partially mesh with the inner teeth 1347 of the rigid wheel 134. When the rotatable portion 1311 of the wave generator 131 is rotated, the flexible wheel 132 is driven to rotate and partially mesh with different inner teeth 1347 of the rigid wheel 134, and the rigid wheel 134 is rotated by the flexible wheel 132 at a speed less than that of the flexible wheel 132 because the number of outer teeth 1327 of the flexible wheel 132 is less than the number of inner teeth 1347 of the rigid wheel 134.

The cross roller bearing 135 includes an outer ring 1351, an inner ring 1353 and a plurality of cross rollers 1354 positioned therebetween. The outer ring 1351 is fixed to the first mechanical arm 11 and the inner ring 1353 is fixedly connected to the second mechanical arm 12.

The wave generator 131, the flexible wheel 132, the rigid wheel 134 and the cross roller bearing 135 are positioned between the first side cover 136 and the second side cover 137. The first side cover 136 is fixed to the first mechanical arm 11, and the second side cover 137 is fixed to the second mechanical arm 12.

The first mechanical arm 11 includes a main portion 112, a first support portion 113 and a second support portion 115. The first and second support portions 113, 115 are formed on an end of the main portion 112, opposite to each other. The main portion 112, the first support portion 113 and the second support portion 115 cooperatively define a receiving groove 116.

The first support portion 113 includes an assembly base 1131 and an outer cover 1134. The assembly base 1131 defines an assembly hole 1132. The wave generator 131 engages the assembly hole 1132 of the first support portion 113, connected to the driving module 21. The first side cover 136, the outer ring 1351 of the cross roller bearing 135, and the flange 1323 are fixedly connected to the first support portion 113. The second side cover 137, the inner ring 1353 of the cross roller bearing 135, and the rigid wheel 134 are fixed together. The outer cover 1134 is fixed to the assembly base 1131, thus enveloping the harmonic speed reducer 13 and the driving module 21.

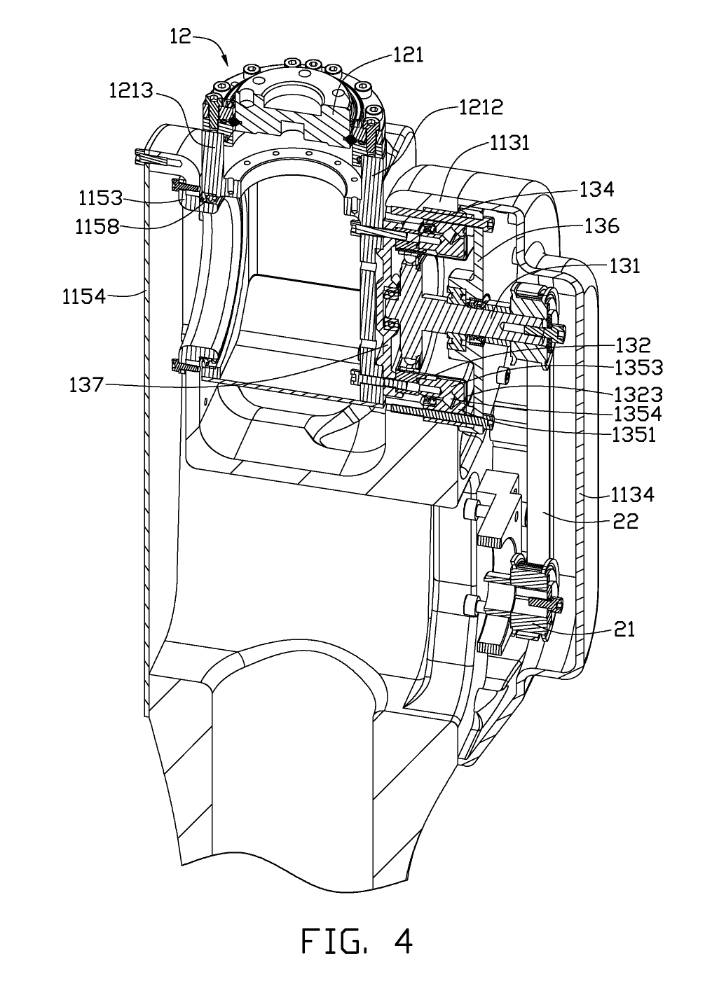

The second support portion 115 includes an assembly base 1150 and a side plate 1154. The assembly base 1150 defines an assembly hole 1151 aligned with the assembly hole 1132 in a straight line. The assembly base 1150 further forms a positioning portion 1153 surrounding the assembly hole 1151 on a first side surface. A wiper 1158 (shown in FIG. 4) is sleeved on the positioning portion 1153. The side plate 1154 is fixed to a second side surface of the assembly base 1150.

The second mechanical arm 12 includes a connecting base 121 and a rotating portion 122 formed on an end thereof. The rotating portion 122 is connected to a tool (not shown), such as a cutter or clamp. The rotating portion 122 is rotated by a driving module (not shown) received in the connecting base 121. The connecting base 121 is received in the receiving groove 116, and connected to the wave generator 131. In the illustrated embodiment, the connecting base 121 is substantially a rectangular housing, and includes a first connecting sidewall 1212 and a second connecting sidewall 1213 opposite to the first connecting sidewall 1212. The first connecting sidewall 1212 defines a circular connecting hole 1215 extending to the second connecting sidewall 1213.

The first connecting sidewall 1212 is fixedly connected to the second side cover 137, the inner ring 1353, and the rigid wheel 134. When the wave generator 131 is rotated by the driving module 21, the rigid wheel 134 rotates with the wave generator 131, and then moves the second mechanical arm 12. The positioning portion 1153 is received in the connecting hole 1215, and the wiper 1158 is positioned between the positioning portion 1153 and the connecting base 121.

It should be pointed out that the second mechanical arm 12 can also be connected to the flexible wheel 132, in which case the first mechanical arm 11 is fixedly connected to the rigid wheel 134 and the outer ring 1351 of the cross roller bearing 135. In addition, in such a case, a load of the second mechanical arm 12 will correspond to that of the harmonic speed reducer 13, whereby the second mechanical arm 12 can move accurately and stably. The load of the second mechanical arm 12 is preferably less than 30 kilograms.

The second mechanical arm 12 is rotatably connected to the first support portion 113 of the first mechanical arm 11 via the harmonic speed reducer 13, and rotated relative to the first mechanical arm 11 by the driving module 21. The second support portion 115 only forms a positioning portion 1153 connected to the second mechanical arm 12. Thus, the mechanical arm assembly 100 is easily assembled, with no need for a bearing positioned on the second support portion 115. In addition, since the harmonic speed reducer 13 utilizes the cross roller bearing 135, a load of the harmonic speed reducer 13 can be greatly improved.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A mechanical arm assembly, comprising:
a first mechanical arm;
a second mechanical arm; and
a harmonic speed reducer rotatably connecting the second mechanical arm to the first mechanical arm, the harmonic speed reducer comprising a wave generator, a flexible wheel, and a rigid wheel, the flexible wheel connected to the wave generator and a portion of the rigid wheel meshed with a portion of the flexible wheel;
wherein one of the flexible wheel and the rigid wheel is fixed to the first mechanical arm, and the other of the flexible wheel and the rigid wheel is fixed to the second mechanical arm, thus supporting the second mechanical arm and causing rotation of the second mechanical arm.

2. The mechanical arm assembly of claim 1, wherein the harmonic speed reducer further comprises a cross roller bearing comprising an outer ring, an inner ring, and a plurality of cross rollers positioned therebetween.

3. The mechanical arm assembly of claim 2, wherein the outer ring is fixedly connected to the first mechanical arm, and the inner ring is fixedly connected to the second mechanical arm.

4. The mechanical arm assembly of claim 1, wherein the first mechanical arm comprises a main portion, a first support portion, and a second support portion; wherein the first and second support portions are disposed on an end of the main portion and opposite to each other and the harmonic speed reducer is positioned on the first support portion.

5. The mechanical arm assembly of claim 4, wherein the second mechanical arm comprises a connecting base, on an end of which a rotating portion is disposed, the connecting base positioned between the first support portion and the second support portion.

6. The mechanical arm assembly of claim 5, wherein the connecting base comprises a first connecting sidewall and a second connecting sidewall opposite thereto; wherein the first connecting sidewall is connected to one of the flexible wheel and the rigid wheel and the second connecting sidewall is attached to the second support portion.

7. The mechanical arm assembly of claim 6, wherein the second connecting sidewall defines a connecting hole, in which a positioning portion on the second support is received.

8. The mechanical arm assembly of claim 7, wherein a wiper is sleeved on the positioning portion, and positioned between the positioning portion and the connecting base.

9. The mechanical arm assembly of claim 1, wherein the harmonic speed reducer further comprises a first side cover and a second side cover, and the wave generator, the flexible wheel, and the rigid wheel are positioned between the first side cover and the second side cover; the first side cover is fixed to the first mechanical arm, and the second side cover is fixed to the second mechanical arm.

10. The mechanical arm assembly of claim 1, wherein the mechanical arm assembly further comprises a driving module to which the wave generator is connected by a transmission member.

11. A mechanical arm assembly, comprising:
a first mechanical arm;
a second mechanical arm; and
a harmonic speed reducer rotatably connecting the first mechanical arm to the second mechanical arm, and capable of rotating the second mechanical arm;
wherein the harmonic speed reducer comprises a cross roller bearing, the cross roller bearing comprises an outer ring, an inner ring and a plurality of cross rollers positioned between the outer ring and the inner ring, and wherein the outer ring is fixedly connected to the first mechanical arm, and the inner ring is fixedly connected to the second mechanical arm.

12. The mechanical arm assembly of claim 11, further comprising a driving module; the harmonic speed reducer further comprises a wave generator for rotating the second mechanical arm, and the wave generator is connected to the driving module by a transmission member.

13. The mechanical arm assembly of claim 11, wherein the first mechanical arm comprises a main portion, a first support portion and a second support portion; the first and second support portions are disposed on an end of the main portion and opposite to each other; the harmonic speed reducer is positioned on the first support portion.

14. The mechanical arm assembly of claim 13, wherein the second mechanical arm comprises a connecting base and a rotating portion on an end of the connecting base, the connecting base positioned between the first support portion and the second support portion.

15. The mechanical arm assembly of claim 14, wherein the connecting base comprises a first connecting sidewall and a second connecting sidewall opposite thereto; wherein the first connecting sidewall is connected to the harmonic speed reducer and the second connecting sidewall is attached to the second support portion.

16. The mechanical arm assembly of claim 15, wherein the second connecting sidewall defines a connecting hole, in which a positioning portion of the second support portion is received.

17. The mechanical arm assembly of claim 16, wherein a wiper is sleeved on the positioning portion, and positioned between the positioning portion and the connecting base.
